(19) United States
(12) Patent Application Publication
(10) Pub. No.: US 2024/0127120 A1
(43) Pub. Date: Apr. 18, 2024

(54) METHOD AND SYSTEM FOR COMPRESSING MODEL FOR NATURAL LANGUAGE UNDERSTANDING WITH LAYER PRUNING

(71) Applicant: NOTA, INC., Daejeon (KR)

(72) Inventor: Hancheol Park, Daejeon (KR)

(73) Assignee: NOTA, INC., Daejeon (KR)

(21) Appl. No.: 18/463,184

(22) Filed: Sep. 7, 2023

(30) Foreign Application Priority Data
Oct. 14, 2022 (KR) 10 2022 0132410

(51) Int. Cl. G06N 20/00; G06F 40/40

(52) U.S. Cl. CPC G06N 20/00; G06F 40/40

(57) ABSTRACT

Disclosed is a model compression method and system for understanding natural language through layer pruning. A model compression method may include adding an internal classification layer to each encoder layer of an input model; measuring performance for an output of the internal classification layer; determining an encoder layer in which the measured performance is lower than performance of the input model by a preset performance drop tolerance range or more; and pruning upper encoder layers of a final layer which is an upper layer of the determined encoder layer.

### CROSS-REFERENCE(S) TO RELATED APPLICATION(S)

This application claims the priority benefit of Korean Patent Application No. 10-2022-0132410, filed on Oct. 14, 2022, in the Korean Intellectual Property Office, the disclosure of which is incorporated herein by reference.

### BACKGROUND

### 1. Field of the Invention

Example embodiments relate to a model compression method and system for understanding natural language through layer pruning.

### 2. Description of the Related Art

To perform a task (e.g., sentence/document classification, sentiment analysis, entailment inference, etc.) that understands meaning of text written in natural language, the use of transformer-based pre-trained language models (PLMs) has recently become a de-facto standard. Examples of a PLM may include bidirectional encoder representations from transformers (BERTs), robustly optimized BERT approach (RoBERTa), XLNet, and the like. The aforementioned PLM refers to a model pre-trained from a language model that predicts a token following a given text, using an encoder network of a transformer and a large corpus. Through prior training, the PLM acquires syntactic knowledge (e.g., parts of speech, word order, etc.) about a large number of vocabularies and general linguistic knowledge, such as pragmatic meaning considering context (e.g., distinguishing whether “bank” specifies “riverbank” or “bank for financial transaction” through context). A method of performing a specific task by fine-tuning a target language understanding task (downstream task) is learned based on the model in which this prior language knowledge is learned. Since this PLM model pre-learns a vast amount of general language knowledge rather than a small amount of language knowledge limited to a task dataset, high generalization performance may be achieved even with respect to data unused for learning, leading to innovative performance improvement in various language understanding tasks. Nevertheless, there is a difficulty in using a transformer-based language model in a situation with limited computing resources.

To use a PLM with limited computing resources, methods, such as a method of pruning a self-attention head or a feed forward network (FFN) within a transformer and a low-rank approximation method of an embedding layer, are used in the related art. Alternatively, a method of constructing a small transformer model and performing knowledge distillation on a large original model, thereby reducing a model size and making performance similar to that of the original model is used.

According to recent study, since a lower encoder layer of a PLM close to an input layer contains general language knowledge pre-learned through language modeling, performance may be significantly degraded if corresponding layers are removed. Also, the recent study shows that, since upper encoder layers close to an output layer encode relevant knowledge required to perform a given task and such knowledge is sufficiently learnable with a small number of layers regardless of a difference according to difficulty of a task, some upper encoder layers may be removed without loss of performance. This layer pruning technique is a most effective method of reducing a size of a model since the layer pruning technique removes an encoder layer that is a larger building block than components treated in the conventional model compression methodology described above.

Nevertheless, there is a difficulty in determining the number of layers to be removed to learn a given dataset. A most general method repeats a process of removing each single layer starting from a final output layer and performing training to determine upper layers to be pruned. However, in the case of Stanford Sentiment Treebank (SST)-2 that is a known sentiment analysis dataset, performance already converges at a fifth layer in a BERT-based model. Therefore, in the case of using the BERT-based model using 12 layers, a total of 8 re-trainings up to a fourth layer in which great performance drop is verified are required. Also, this simple methodology is not considered for methodology of performing additional layer pruning.

A reference material includes Korean Patent Laid-Open Publication No. 10-2022-0048832.

### SUMMARY

Example embodiments may provide a model compression method and system that may compress a pre-trained language model (PLM) by efficiently determining a layer location for layer pruning.

According to an example embodiment, there is provided a model compression method performed by a computer device including at least one processor, the model compression method including adding, by the at least one processor, an internal classification layer to each encoder layer of an input model; measuring, by the at least one processor, performance for an output of the internal classification layer; determining, by the at least one processor, an encoder layer in which the measured performance is lower than performance of the input model by a preset performance drop tolerance range or more; and pruning, by the at least one processor, upper encoder layers of a final layer which is an upper layer of the determined encoder layer.

According to an aspect, the adding of the internal classification layer may include freezing a weight of the input model to a constant and then simultaneously training the internal classification layer added to each encoder layer for a target task.

According to another aspect, the simultaneously training may include simultaneously training the internal classification layer using a cross-entropy loss function.

According to still another aspect, the simultaneously training may include simultaneously training the internal classification layer using the same hyperparameter values used for fine tuning of the input model.

According to still another aspect, the measuring of the performance for the output of the internal classification layer may include measuring performance for an output of each encoder layer to which the internal classification layer is added using verification data used for evaluation of the input model.

According to still another aspect, the performance drop tolerance range may be determined based on M % of performance of the input model using verification data used for evaluation of the input model, and M denotes a positive rational number.

According to still another aspect, the model compression method may further include determining a lower pruning limit of layers included in the model.

According to still another aspect, the determining of the lower pruning limit may include measuring performance after rollback weights of each layer of the model to weights of the model before training for a target task starting from a layer closest to an input layer of the model; and determining a layer in which the measured performance starts to fall below a preset threshold as the lower pruning limit.

According to still another aspect, the model compression method may further include performing additional pruning when the model derived by pruning the upper encoder layers of the final layer has more layers than the lower pruning limit.

According to still another aspect, the performing of the additional pruning may include setting at least one layer higher than the lower pruning limit among the layers of the calculated model as a layer for additional pruning; performing the additional pruning for the set at least one layer; and performing internal knowledge distillation from a lower layer of the final layer after performing the additional pruning.

According to still another aspect, the performing of the internal knowledge distillation may include performing knowledge distillation using a loss function that is calculated based on a correct answer label in a form of a one-hot label, a distribution predicted for the final layer, a distribution predicted for the lower layer of the final layer, and a cross-entropy loss function.

According to still another aspect, the model may include a transformer-based pre-trained language model (PLM).

According to an example embodiment, there is provided a non-transitory computer-readable recording medium storing instructions that when executed by a processor, cause the processor to perform the method.

According to an example embodiment, there is provided a computer device including at least one processor configured to execute computer-readable instructions. The at least one processor is configured to add an internal classification layer to each encoder layer of an input model, to measure performance for an output of the internal classification layer, to determine an encoder layer in which the measured performance is lower than performance of the input model by a preset performance drop tolerance range or more, and to prune upper encoder layers of a final layer which is an upper layer of the determined encoder layer.

According to some example embodiments, it is possible to compress a PLM by efficiently determining a layer location for layer pruning. In detail, layers to be pruned may be found with low computational cost and a degree of compression may be improved through additional layer pruning.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating an example of a computer device according to an example embodiment;

FIG. 2 is a flowchart illustrating an example of a model compression method for calculating a compressed pre-trained language model (PLM) through layer pruning according to an example embodiment;

FIG. 3 is a flowchart illustrating an example of a method for additional pruning according to an example embodiment; and

FIG. 4 illustrates an example of a prediction distribution of layers according to an example embodiment.

### DETAILED DESCRIPTION

Hereinafter, example embodiments will be described with reference to the accompanying drawings.

A model compression system according to example embodiments may be implemented by at least one computer device. Here, a computer program according to an example embodiment may be installed and executed on the computer device, and the computer device may perform the model compression method according to example embodiments under control of the executed computer program. The computer program may be stored in computer-readable recording media to computer-implement the model compression method in conjunction with the computer device.

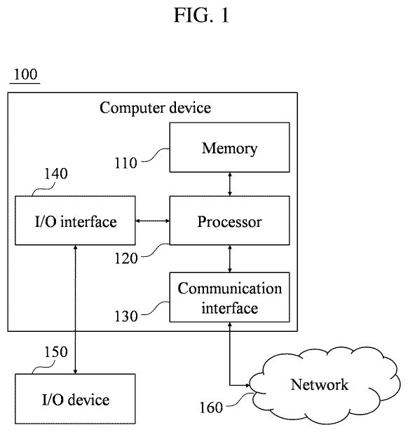

FIG. 1 is a diagram illustrating an example of a computer device according to an example embodiment. Referring to FIG. 1, a computer device 100 may include a memory 110, a processor 120, a communication interface 130, and an input/output (I/O) interface 140. The memory 110 may include a permanent mass storage device, such as a random access memory (RAM), a read only memory (ROM), and a disk drive, as a non-transitory computer-readable recording medium. Here, the permanent mass storage device, such as a ROM and a disk drive, may be included in the computer device 100 as a permanent storage device separate from the memory 110. Also, an OS and at least one program code may be stored in the memory 110. Such software components may be loaded to the memory 110 from another non-transitory computer-readable recording medium separate from the memory 110. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 110 through the communication interface 130, instead of the non-transitory computer-readable recording medium. For example, the software components may be loaded to the memory 110 of the computer device 100 based on a computer program installed by files received over a network 160.

The processor 120 may be configured to process instructions of a computer program by performing basic arithmetic operations, logic operations, and I/O operations. The computer-readable instructions may be provided by the memory 110 or the communication interface 130 to the processor 120. For example, the processor 120 may be configured to execute received instructions in response to a program code stored in a storage device, such as the memory 110.

The communication interface 130 may provide a function for communication between the communication device 100 and another apparatus. For example, the processor 120 of the computer device 100 may forward a request or an instruction created based on a program code stored in the storage device such as the memory 110, data, and a file, to other apparatuses over the network 160 under control of the communication interface 130. Inversely, a signal, an instruction, data, a file, etc., from another apparatus may be received at the computer device 100 through the communication interface 130 of the computer device 100. For example, a signal, an instruction, data, etc., received through the communication interface 130 may be forwarded to the processor 120 or the memory 110, and a file, etc., may be stored in a storage medium, for example, the permanent storage device, further includable in the computer device 100.

The I/O interface 140 may be a device used for interfacing with an I/O device 150. For example, an input device may include a device, such as a microphone, a keyboard, a mouse, etc., and an output device may include a device, such as a display, a speaker, etc. As another example, the I/O interface 140 may be a device for interfacing with an apparatus in which an input function and an output function are integrated into a single function, such as a touchscreen. The I/O device 150 may be configured as a single apparatus with the computer device 100.

Also, according to other example embodiments, the computer device 100 may include a greater or smaller number of components than the number of components of FIG. 1. However, there is no need to clearly illustrate many conventional components. For example, the computer device 100 may be configured to include at least a portion of the I/O device 150 or may further include other components, such as a transceiver and a database.

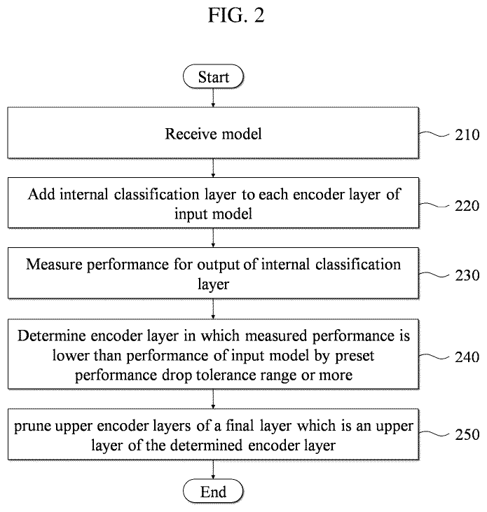

FIG. 2 is a flowchart illustrating an example of a model compression method for calculating a compressed PLM through layer pruning according to an example embodiment. The model compression method according to the example embodiment may be performed by the computer device 100 of FIG. 1. Here, the processor 120 of the computer device 100 may be configured to execute a control instruction according to a code of at least one computer program or a code of an OS included in the memory 110. Here, the processor 120 may control the computer device 100 to perform operations 210 and 250 included in the method of FIG. 2 according to a control instruction provided from a code stored in the computer device 100.

In operation 210, the computer device 100 may receive a model. Here, the model may include a transformer-based pre-trained language model (PLM). This PLM may be fine-tuned using a target task and may include, for example, a bidirectional encoder representation from transformer (BERT), robustly optimized BERT approach (RoBERTa), XLNet, and the like.

In operation 220, the computer device 100 may add an internal classification layer to each encoder layer of the input model. For example, the computer device 100 may freeze a weight to not a variable but a constant, to prevent the weight of the PML as the model that is received in operation 210 from being learned anymore and then may add the internal classification layer to each encoder layer. The internal classification layers added to the respective layers may be simultaneously trained for a target task. Here, in the case of a natural language understanding task, a loss function for training relates to a classification model and may use a cross-entropy loss function. For example, the computer device 100 may simultaneously train the internal classification layers for the target task by performing model training using an overall loss function of Equation 1 below.

Σᵢ₌₁ⁿ⁻¹Lᵢ [Equation 1]

In Equation 1, n denotes an index of a layer and Lᵢ denotes a cross-entropy loss function in a classifier added to an i-th layer.

Here, a configuration of hyperparameters for training (e.g., epoch, batch size, etc.) may use the same values used for fine-tuning the input PLM. That is, the computer device 100 may simultaneously train the internal classification layer using the same hyperparameter values used for fine-tuning of the model.

In operation 230, the computer device 100 may measure performance for an output of the internal classification layer. In this case, the computer device 100 may measure performance for output of each encoder layer to which the internal classification layer is added using verification data used for evaluation of the input model. For example, the computer device 100 may measure the performance for the output of the internal classification layer by measuring performance of a sub-model that includes layers from an initial layer of the input model to the encoder layer to which the internal classification layer is added.

In operation 240, the computer device 100 may determine an encoder layer in which the measured performance is lower than performance of the input model by a preset performance drop tolerance range or more. Here, the performance drop tolerance range may be determined based on M % of performance of the input model using verification data used for evaluation of the input model. Here, M denotes a positive rational number. For example, the computer device 100 may measure performance of each layer and then identify an encoder layer in which performance starts to show lower than a predesignated performance drop tolerance range (e.g., M % of performance of the original model for the verification data).

In operation 250, the computer device 100 may prune upper encoder layers of a final layer which is an upper encoder layer of the determined encoder layer. That is, the computer device 100 may set the upper encoder layer of the encoder layer determined in operation 240 as the final layer and may remove all of encoder layers higher than the final layer through pruning. Since a classifier is already trained, re-training may not be performed. In this manner, layers to be pruned may be selected to perform layer pruning with only a total of one training. Therefore, computational cost for selecting layers to be pruned may be significantly improved.

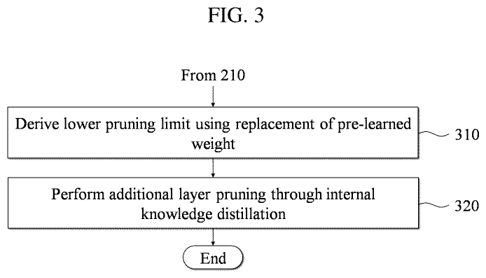

FIG. 3 is a flowchart illustrating a method for additional pruning according to an example embodiment. Among operations 310 and 320 included in the method for additional pruning according to the example embodiment, operation 310 may be performed in parallel with other operations 220 to 250 of FIG. 2 after operation 210 described above with reference to FIG. 2. Also, operation 320 may be performed after operation 250 of FIG. 2.

In operation 310, the computer device 100 may derive a lower pruning limit using replacement (rollback) for a pre-learned weight. That is, the computer device 100 may determine the lower pruning limit of layers included in the model input in operation 210. In detail, for example, the computer device 100 may measure performance after replacing weights of each layer of the model with weights of a language model pre-trained before being trained for a target task, starting from a layer closest to the input layer of the input PLM. In the conventional study, since weights of lower layers containing pre-learned language knowledge rarely vary during fine-tuning, it is verified that there is no change in performance although weights of some lower layers of the fine-tuned model are replaced (rolled back) with weights of the pre-trained language model before fine-tuning.

Therefore, the example embodiment may distinguish layers that encode linguistic knowledge using replacement for a pre-learned weight. The computer device 100 may assume, as the lower pruning limit, a layer in which a performance drop starts to occur by N % or more when performing weight replacement. Here, N denotes a positive rational number. That is, pruning may not be allowed below a layer that is set as the lower pruning limit. Under this assumption, a layer immediately preceding the layer in which the performance drop starts to occur by N % or more may be assumed as a layer that encodes linguistic knowledge and at least one encoder layer is left to be used for learning a task. This method may be applied only to a PLM due to an inherent characteristic of the PLM that pre-trains the language model.

This operation 310 involves a plurality of performance measurements to determine the lower pruning limit, but requires relatively much less computational cost compared to training a plurality of times.

In operation 320, the computer device 100 may perform additional layer pruning through internal knowledge distillation. For example, when the model derived by pruning upper encoder layers of the final layer set in operation 250 has more layers than the lower pruning limit, the computer device 100 may perform additional pruning. For example, when the number of layers of the model derived through pruning in operation 250 is 8 and the lower pruning limit is a fifth layer, a sixth layer, a seventh layer, and an eighth layer that are higher layers than the lower pruning limit may be subjects to be additionally pruned.

Here, additional pruning accompanies performance drop. To solve this, the example embodiment may perform an internal knowledge distillation technique.

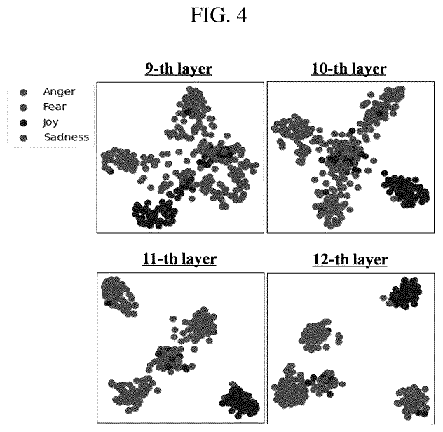

FIG. 4 illustrates an example of a prediction distribution of layers according to an example embodiment. Referring to the prediction distribution of FIG. 4, the higher a layer of a PLM (e.g., an 11-th layer and a 12-th layer of FIG. 4), the higher the prediction distribution appears to express strong over-confidence for a specific label and is predicted to be close to a one-hot label accordingly. In a relatively lower layer, samples related to an input sample are distributed closely and relationship between each sample and other labels is expressed to some extent and predicts a soft label accordingly. In a general knowledge distillation method, a large-sized teacher model (teacher network) expresses relationship information between each sample and similar labels more accurately than a small-sized student model (student network). This distribution is based on observation that performance may be improved since generalization information indicating labels similar to a specific sample is included. However, since a model that performs layer pruning in the example embodiment already sufficiently contains generalization information, the performance may not be improved when performing general knowledge distillation using a final output of a large-sized teacher model having relatively strong over-confidence compared thereto. To solve this issue, the example embodiment performs internal knowledge distillation by performing knowledge distillation starting from a layer one level below that contains slightly more generalization information than a layer to be additionally pruned. Since the knowledge distillation uses distribution of each layer, distribution from the internal classification layer trained additionally in operation S220 may be used.

The loss function for the internal knowledge distillation may be defined as in Equation 2 below.

L_{KD}=L_{ce}(y̅ₜ,y)+λL_{ce}(y̅ₜ,y̅ₛ)

In Equation 2, y denotes a correct answer label in a form of a one-hot label, y̅ₜ denotes a distribution predicted for the final layer after performing additional pruning, y̅ₛ denotes a distribution predicted for an immediately previous layer of y̅ₜ (lower layer of y̅ₜ), and L_{ce} denotes a cross-entropy loss function.

In Equation 2, a first term on the right refers to a term that is designed to prevent performance drop since distribution information derived from a lower layer may be an incorrect distribution that does not predict a correct label. A second term also controls an amount of information to be extracted from a lower layer and, as a value of λ increases, performance degradation is highly likely to occur.

In the case of performing training using a slightly softer label than a one-hot label, such as a label smoothing method, as a similar conventional methodology, the performance may be significantly improved. Although a soft label is generated through human intuition of label smoothing, the model generates a soft label used in example embodiments through training. Therefore, correlation between each sample and labels may be well expressed to some extent.

As described above, according to example embodiments, the computer device 100 may output the compressed model to which pruning is processed in operation 250 or may output the compressed model to which pruning, additional pruning, and internal knowledge distillation are processed in operation 320.

As described above, according to example embodiments, it is possible to compress a PLM by efficiently determining a layer location for layer pruning. In detail, layers to be pruned may be found with low computational cost and a degree of compression may be improved through additional layer pruning.

The systems and/or the apparatuses described herein may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of the program instructions include a machine language code such as produced by a compiler and an advanced language code executable by a computer using an interpreter.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. A model compression method performed by a computer device comprising at least one processor, the model compression method comprising:
adding, by the at least one processor, an internal classification layer to each encoder layer of an input model;
measuring, by the at least one processor, performance for an output of the internal classification layer;
determining, by the at least one processor, an encoder layer in which the measured performance is lower than performance of the input model by a preset performance drop tolerance range or more; and
pruning, by the at least one processor, upper encoder layers of a final layer which is an upper layer of the determined encoder layer.

2. The model compression method of claim 1, wherein the adding of the internal classification layer comprises freezing a weight of the input model to a constant and then simultaneously training the internal classification layer added to each encoder layer for a target task.

3. The model compression method of claim 2, wherein the simultaneously training comprises simultaneously training the internal classification layer using a cross-entropy loss function.

4. The model compression method of claim 2, wherein the simultaneously training comprises simultaneously training the internal classification layer using the same hyperparameter values used for fine tuning of the input model.

5. The model compression method of claim 1, wherein the measuring of the performance for the output of the internal classification layer comprises:
measuring performance for an output of each encoder layer to which the internal classification layer is added using verification data used for evaluation of the input model.

6. The model compression method of claim 1, wherein the performance drop tolerance range is determined based on M % of performance of the input model using verification data used for evaluation of the input model, and M denotes a positive rational number.

7. The model compression method of claim 1, further comprising:
determining a lower pruning limit of layers included in the model.

8. The model compression method of claim 7, wherein the determining of the lower pruning limit comprises:
measuring performance after rollback weights of each layer of the model to weights of the model before training for a target task starting from a layer closest to an input layer of the model; and
determining a layer in which the measured performance starts to fall below a preset threshold as the lower pruning limit.

9. The model compression method of claim 7, further comprising:
performing additional pruning when the model derived by pruning the upper encoder layers of the final layer has more layers than the lower pruning limit.

10. The model compression method of claim 9, wherein the performing of the additional pruning comprises:
setting at least one layer higher than the lower pruning limit among the layers of the derived model as a layer for additional pruning;
performing the additional pruning for the set at least one layer; and
performing internal knowledge distillation from a lower layer of the final layer after performing the additional pruning.

11. The model compression method of claim 10, wherein the performing of the internal knowledge distillation comprises:
performing knowledge distillation using a loss function that is calculated based on a correct answer label in a form of a one-hot label, a distribution predicted for the final layer, a distribution predicted for the lower layer of the final layer, and a cross-entropy loss function.

12. The model compression method of claim 1, wherein the model includes a transformer-based pre-trained language model (PLM).

13. A non-transitory computer-readable recording medium storing instructions that when executed by a processor, cause the processor to implement the method of claim 1 in a computer device.

14. A computer device comprising:
at least one processor configured to execute computer-readable instructions,
wherein the at least one processor is configured to:
add an internal classification layer to each encoder layer of an input model,
measure performance for an output of the internal classification layer,
determine an encoder layer in which the measured performance is lower than performance of the input model by a preset performance drop tolerance range or more, and
prune upper encoder layers of a final layer which is an upper layer of the determined encoder layer.

15. The computer device of claim 14, wherein, to add the internal classification layer, the at least one processor is configured to freeze a weight of the input model to a constant and then simultaneously train the internal classification layer added to each encoder layer for a target task.

16. The computer device of claim 14, wherein, to measure the performance for the output of the internal classification layer, the at least one processor is configured to measure performance for an output of each encoder layer to which the internal classification layer is added using verification data used for evaluation of the input model.

17. The computer device of claim 14, wherein the performance drop tolerance range is determined based on M % of performance of the input model using verification data used for evaluation of the input model, and M denotes a positive rational number.

18. The computer device of claim 14, wherein the at least one processor is configured to determine a lower pruning limit of layers included in the model.

19. The computer device of claim 18, wherein the at least one processor is configured to perform additional pruning when the model derived by pruning the upper encoder layers of the final layer has more layers than the lower pruning limit.
